(19) United States
(12) Patent Application Publication
(10) Pub. No.: US 2022/0312811 A1
(43) Pub. Date: Oct. 6, 2022

(54) METHOD FOR CREATING MEAL REPLACEMENT DIETARY PRODUCTS

(71) Applicant: Scott Joseph, Davie, FL (US)

(72) Inventor: Scott Joseph, Davie, FL (US)

(21) Appl. No.: 17/216,975

(22) Filed: Mar. 30, 2021

(51) Int. Cl. A23L 19/00; A23L 33/00; A23L 25/00; A23L 2/02

(52) U.S. Cl. CPC A23L 19/09; A23L 33/40; A23L 33/30; A23L 25/30; A23L 2/02; A23V 2002/00

(57) ABSTRACT

Embodiments of the invention relate to meal replacement dietary products and methods for producing them. In some embodiments, the dietary products consist of raw, whole foods blends that create portioned meal replacement products, which are distinguished from juices. In some embodiments, the dietary products consist of approximately, by weight, 85% fruits, 5% vegetables, 5% nuts, and 5% seeds of a total dietary product, not including water and consisting of a variety of highly absorbable nutrients based on fruits, vegetables, nuts, and seeds. In some embodiments, the entire foods are used to include: peels, seeds, stems, husks, etc. The resulting dietary products deliver nutrient reach meals.

### FIELD

Embodiments disclosed relate to meal replacement dietary products and methods for creating the meal replacement dietary products, and in particular, to dietary products and methods for making them that provide dietary benefits derived from the synergy of combining certain edible products in non-naturally occurring combinations.

### BACKGROUND

As the dietary and prepared food industries continue to expand, the demand for efficient meal replacement products continue to grow. Consumers are more health conscious and are seeking meal replacement options that are healthier than current options such as Boost®, Ensure®, and Slimfast®. Further, consumers seek products that are based on raw, whole, and natural foods and are nutrient rich and perfectly portioned. Many popular manufacturers have attempted to replicate popular dietary trends, creating low fat, high protein, vitamin rich versions of popular diets such as Atkins®, TLC, SouthBeach®, and DASH®.

Similarly, there are few meal replacement products that provide real, raw, whole food attributes that are not heavily processed and pasteurized. Currently, pasteurization remains the most prominent method used for meal replacement products. Of these pasteurization methods, the most popular method for processing non-refrigerated meal replacement products' storage is through Ultra High Temperature (UHT) pasteurization.

Conversely, diets based on simple foods that are real, raw and whole used in pre-historic times have begun to gain popularity.

Accordingly, there is a need for meal replacement dietary products that are nutrient rich, appropriately portioned, and offer more than a simple juice, without the drawbacks of pasteurized drinks.

### SUMMARY OF THE INVENTION

Embodiments disclose relate to meal replacement dietary products and to methods for creating them. Such dietary products, as disclosed herein, can be made of non-naturally occurring combinations of, for example, fruits, vegetables, leaves, buds, stems, pith, bark, nuts, and seeds.

One embodiment of a dietary product according to the inventive principles disclosed here contains about 75% to 85% fruits, about 2% to 5% vegetables, about 2% to 5% nuts, and ab out 2% to 5% seeds of the total product, by weight, consisting of a variety of highly absorbable nutrients based on fruits, vegetables, nuts, and seeds. In some embodiments, the dietary products may be combined with other ingredients, such as cacao, cinnamon flavoring, and the like, to provide color and flavor characteristics familiar to consumers.

In one embodiment, a dietary product contains at least one of grapes, bananas, pears, or blueberries, lettuce, and almonds. In another embodiment, a dietary product contains at least one of oranges, bananas, pears, or strawberries, lettuce, and almonds. In yet another embodiment, the dietary product contains at least one of pineapples, bananas, pears, or strawberries, lettuce, and almonds. In one embodiment, the dietary product contains at least one of apples, bananas, pears, or strawberries, lettuce, and almonds.

In one embodiment, the invention is directed to a method of producing the dietary products. The method includes: (1) providing the following ingredients, by weight, 75% to 85% fruits, 2% to 5% vegetables, 2% to 5% nuts, and 2% to 5% seeds; (2) and mixing and blending the fruits, vegetables, nuts, and seeds. In some embodiments, the fruits, vegetables, nuts, and seeds may be mixed and blended with fruit juices and/or water in a plurality of ways to provide a variety of flavors and to produce a nutritional benefit that cannot be found in a single ingredient. The resulting dietary product is not found in nature and has its dietary benefits only in the synergistic mix and blend of ingredients in the percentages provided. Such dietary product is readily digestible and is a well-rounded nutritional meal, which provides the added benefit that a consumer does not have to eat a variety of foods separately.

Other aspects, advantages, and novel features of the present invention will become apparent from the following detailed description.

### DETAILED DESCRIPTION

The method of the embodiment will be described as a sequence of steps. However, it must be understood that the sequence of steps may change with blending and mixing technology. The individual ingredients listed above may be added in whole or part in a plurality of steps. These variations are used to achieve the most thorough blending that results in nutrient rich products (not a juice), and any variable known to persons skilled in the relevant field.

The terminology used herein is for the purpose of describing exemplary embodiments only and is not intended to be limiting. As used here, “mixing” generally refers to putting together multiple substances to form a new product. In this context, mixing involves both dry and wet ingredients. The mixing operation is usually a comprehensive one—resulting in highly homogenous composition.

As used here, “blending” generally refers to mixing only dry ingredients. Blending involves combining different varieties of ingredients. Sometimes blending involves a small amount of liquid, such as when producing granules. If the majority of the ingredients are dry, it is a blending process. Blending is a gentler process than mixing. The aim is to create a uniform distribution of each component in the final blend. It's not to mish-mash all the ingredients together. Most industrial-grade blenders make it a point to minimize ingredient contact with the blender's blades.

Proper blending is a necessary process to create a consistent product. Without proper blending of flour and sugar, for example, the result can be an overly sweet product in one box, and a course, gritty product in another. This is because the ratio of flour or sugar would vary widely with each batch produced if the ingredients are not blended well.

In particular, “berry” and “fruit” may at times be used interchangeably, although berries are a subset of fruit. “Nuts” are listed separately from “seeds,” although some nuts may be seeds. Also, the term “seeds” is used in two senses; first, to denote the seeds used in these embodiments as seeds only, and second, to refer to the seeds that are part of other ingredients (such as the fruits) in these embodiments. Embodiments disclosed can include ingredients such as apples, apricots, arugula, bananas, blackberries, blueberries, cherries, cranberries, kiwi, mangos, monk fruit, oranges, peaches, pears, raspberries, strawberries, almonds, cashews, pecans, pistachios, walnuts, broccoli, Brussels sprouts, carrots, eggplant, pumpkin, romaine lettuce, spinach, sweet potatoes, yellow squash, pear seeds, orange seeds, grape seeds, pineapple seeds, pumpkin seeds, strawberry seeds, sunflower seeds, apple seeds, banana seeds, blueberry seeds, chia seeds, flax seeds, or sesame seeds. Not every type of ingredient listed above is necessary to formulate the dietary products. Different combinations of ingredients may lead to similar results.

Some studies have found that the combination and manner of processing of certain foods can act synergistically to affect the digestive glycemic response that is different from that expected of the individual food ingredients. In one study, which is incorporated by reference herein in its entirety, the response of blood glucose plasma insulin to nine diets with different components of foods were tested. Cui H, Yang Y, Bian L, He M., Effect of food composition of mixed food on glycemic index. Wei Sheng Yan Jiu. 1999 November; 28(6):356-8. Chinese. PMID: 12016989. The study concluded that protein and dietary fiber of mixed food could markedly affect the glycemic index of foods and reduce the blood glucose response. Id. Another study, which is incorporated by reference herein in its entirety, discusses that “for those who need to maintain a healthy diet, it is beneficial to regulate appropriate levels of blood glucose. [And] what influences the meal GI [glucose index] or GL [glucose load] depends on the macronutrient composition and the physical chemistry reactions in vivo.” Jiyoung S. Kim, Kisun Nam, Sang-Jin Chung, Effect of nutrient composition in a mixed meal on the postprandial glycemic response in healthy people: a preliminary study. Nutrition Research and Practice, 2019: 13(2):126-133. This study concludes that a “mixed meal containing three macronutrients [rice, eggs, soybean, and oil] decreased the PPGR [postprandial glucose response] in healthy individuals, leading to significantly lower actual GI and GL values than those derived by nutrient-based calculations. Thus, consuming various macronutrients containing meals is beneficial in regulating PPGR”. Id. Similarly, the non-naturally occurring dietary food products disclosed herein, being blends and mixes of various macronutrient containing ingredients, produce synergistic effects for digestive glycemic response that are not produced by each individual ingredient that is included in any one of the dietary food products, in the multiple embodiments, of the invention disclosed herein.

In one embodiment, a dietary product may contain 85% fruits, 5% vegetables, 5% nuts, and 5% seeds, all of which are pureed in their raw form, including their edible peels, skins, stems, and seeds. “Edible” is broadly defined to incorporate plant matter that is nonpoisonous and able to be swallowed when pureed and blended. For example, an apple core is edible when it and its seeds are pureed and blended as part of the current embodiment. Similarly, a banana peel is edible. A liquid admixture like potable water and/or juice may be blended with the raw puree to produce a desirable consistency for consumers.

Monk fruit may be added as a flavoring agent and natural sweetener, but the flavoring agent or natural sweetener is not limited to Monk fruit. Monk fruit may be sourced as an extract, powder, or other derivative, or fresh or dried leaves. In a preferred embodiment, a dietary food incorporates dried monk fruit leaves, which are sweeter than fresh leaves.

Different combinations of ingredients can produce similar results the dietary product for human consumption. One embodiment may contain a plurality of fruits, a plurality of vegetables, a plurality of nuts, and a plurality of seeds. However, a combination including only one or two of a particular food group may bring a similar result. Likewise, the percent of caloric intake for a particular food group may vary within a range and bring a similar result. For example, a raw puree may comprise, by weight, at least 75%-85% fruits, at least 2% to 5% vegetables, at least 2% to 5% nuts, and at least 2% to 5% seeds. The raw puree may include at least one peel or skin, at least one stem, and at least one fruit seed, for example.

In one embodiment, the dietary product is raw, uncooked and thicker than a typical juice. A serving size can be, for example, a 16 fluid ounce bottle (473 mL), and a consumer may eat a serving in place of a meal—such as breakfast, lunch, or dinner. Eating these nutrient-dense servings may closely provide a full day's supply of foods a human body need. A preferred serving size can also be 12-fluid ounces or 8-fluid ounces, for example.

Pureeing and blending facilitate a greater absorption of nutrients. The distinction between blending and juicing is important. Juicing removes the fiber and produces sugary water, but blending allows consumption of the entire food, including the pulp. The pulp is fiber that keeps the digestive tract healthy and slows down the absorption of sugar. As is well known in the art, plant-based carbohydrates can regulate blood sugar levels, lower cholesterol, and leave a person feeling fuller longer

Fruits, vegetables, nuts, and seeds, are rich in vitamins, minerals, and enzymes. Enzymes act as a natural digestive aid. Consuming raw maximizes the nutritional value versus cooking or pasteurizing.

Example 1. In one embodiment, a dietary product is a Mixed Berries product that consists of grapes, bananas, pears, blueberries, lettuce, almonds, monk fruit, and water. The content of grapes, bananas, pears, or blueberries in the Mixed Berries product is, by weight, about 75% to about 85%. The content of the lettuce in the Mixed Berries product is, by weight, about 2% to about 5%. The content of the almonds in the Mixed Berries product is, by weight, about 2% to about 5%. The Mixed Berries product includes all of the seeds present in each of the grapes, bananas, pear, and blueberries. The content of the seeds in the Mixed Berries product is, by weight, about 2% to about 5%. Edible peels, skins, seeds, and stems are included. A serving (12 oz) of the Mixed Berries product contains about 80 calories, 0.5 g fat, 19 g carbohydrates, and 1 g protein.

Example 2. In one embodiment, a dietary product is a Strawberry Orange product that consists of oranges, bananas, pears, strawberries, lettuce, almonds, and monk fruit. Edible peels, skins, seeds, and stems are included. A serving (12 oz) of the Strawberry Orange product contains about 70 calories, 0.5 g fat, 17 g carbohydrates, and 1 g protein. The content of oranges, bananas, pears, or strawberries in the Strawberry Orange product is, by weight, about 75% to about 85%. The content of the lettuce in the Strawberry Orange product is, by weight, about 2% to about 5%. The content of the almonds in the Strawberry Orange product is, by weight, about 2% to about 5%. The Strawberry Orange product includes all of the seeds present in each of the oranges, bananas, pears, or strawberries. The content of the seeds in the Strawberry Orange product is, by weight, about 2% to about 5%.

Example 3. In one embodiment, a dietary product is a Pineapple Banana product that consists of pineapples, bananas, pears, strawberries, lettuce, almonds, and monk fruit. Edible peels, skins, seeds, and stems are included. Edible peels, skins, seeds, and stems are included. A serving (12 oz) of the Pineapple Banana product contains about 50 calories, 0.5 g fat, 12 g carbohydrates, and 1 g protein. The content of pineapples, bananas, pears, or strawberries in the Pineapple Banana product is, by weight, about 75% to about 85%. The content of the lettuce in the Pineapple Banana product is, by weight, about 2% to about 5%. The content of the almonds in the Pineapple Banana product is, by weight, about 2% to about 5%. The Pineapple Banana product includes all of the seeds present in each of the pineapples, bananas, pears, or strawberries. The content of the seeds in the Pineapple Banana product is, by weight, about 2% to about 5%.

Example 4. In one embodiment, a dietary product is an Apple Strawberry product that contains apples, bananas, pears, strawberries, lettuce, almonds, and monk fruit. Edible peels, skins, seeds, and stems are included. A serving (12 oz) of the Apple Strawberry product contains about 80 calories, 0.5 g fat, 20 g carbohydrates, and 1 g protein. The content of apples, bananas, pears, or strawberries, in the Apple Strawberry product is, by weight, about 75% to about 85%. The content of the lettuce in the Apple Strawberry product is, by weight, about 2% to about 5%. The content of the almonds in the Apple Strawberry product is, by weight, about 2% to about 5%. The Apple Strawberry product includes all of the seeds present in each of the pineapples, bananas, pears, or strawberries. The content of the seeds in the Apple Strawberry product is, by weight, about 2% to about 5%.

Not every ingredient listed above is necessary to successfully formulate a dietary product according to the inventive principles disclosed here. Rather, the mixes described are representative, and each ingredient may be used independently or in combination to represent its food group if that ingredient is used at all.

In one embodiment, the invention is addressed to a method of producing dietary product using these steps: (1) providing, portioning, and pureeing about 85% fruits, about 5% vegetables, about 5% nuts, and about 5% seeds by weight; and (2) mixing and blending the fruits, vegetables, nuts, and seeds in a water along with their edible peels, skins, stems, and seeds. The individual ingredients listed above may be added in whole or part in a plurality of steps. Seen in conjunction with the above-detailed description of the raw, whole food dietary product, this method may accommodate a range of ingredients and processes, and it is understood that the sequence of steps may change with blending and mixing technology.

What is claimed is:

1. A dietary product composition with a digestive glycemic response, produced by a non-nature-made combination of ingredients, that is different from the digestive glycemic response produced by each individual ingredient, the composition by weight content comprising:
at least about 75% to 85% fruits;
at least about 2% to 5% vegetables;
at least about 2% to 5% nuts; and
at least about 2% to 5% seeds.

2. The dietary product composition of claim 1 comprising at least about 85% fruits, at least about 5% vegetables, at least about 5% nuts, and at least about 5% seeds.

3. The dietary product composition of claim 1, wherein the fruits comprise at least one of grapes, bananas, pears, or blueberries, and wherein the vegetables comprise at least lettuce, and wherein the nuts comprise at least almonds.

4. The dietary product composition of claim 3, wherein the at least about 2% to 5% seeds are seeds present in the grapes, bananas, pears, or blueberries.

5. The dietary product composition of claim 1, wherein the fruits comprise at least one of oranges, bananas, pears, or strawberries, and wherein the vegetables comprise at least lettuce, and wherein the nuts comprise at least almonds.

6. The dietary product composition of claim 5, wherein the at least about 2% to 5% seeds are seeds present in the oranges, bananas, pears, or strawberries.

7. The dietary product composition of claim 1, wherein the fruits comprise at least one of pineapples, bananas, pears, or strawberries, and wherein the vegetables comprise at least lettuce, and wherein the nuts comprise at least almonds.

8. The dietary product composition of claim 7, wherein the at least about 2% to 5% seeds are seeds present in the pineapples, bananas, pears, or strawberries.

9. The dietary product composition of claim 1, wherein the fruits comprise at least one of apples, bananas, pears, or strawberries, and wherein the vegetables comprise at least lettuce, and wherein the nuts comprise at least almonds.

10. The dietary product composition of claim 9, wherein the at least about 2% to 5% seeds are seeds present in the apples, bananas, pears, or strawberries.

11. A method of creating a meal replacement dietary product for producing a digestive glycemic response that is not produced when the ingredients are consumed separately and in amounts different to those found in the meal replacement dietary product, the method comprising:
providing by weight content at least about:
75% to 85% fruits;
2% to 5% vegetables;
2% to 5% nuts;
2% to 5% seeds; and
mixing and blending the fruits, vegetables, nuts, and seeds.

12. The method of claim 11 comprising at least about 85% fruits, at least about 5% vegetables, at least about 5% nuts, and at least about 5% seeds.

13. The method of claim 11, wherein the fruits comprise at least one of grapes, bananas, pears, or blueberries, and wherein the vegetables comprise at least lettuce, and wherein the nuts comprise at least almonds.

14. The method of claim 11, wherein the fruits comprise at least one of oranges, bananas, pears, or strawberries, and wherein the vegetables comprise at least lettuce, and wherein the nuts comprise at least almonds.

15. The method of claim 11, wherein the fruits comprise at least one of pineapples, bananas, pears, or strawberries, and wherein the vegetables comprise at least lettuce, and wherein the nuts comprise at least almonds.

16. The method of claim 11, wherein the fruits comprise at least one of apples, bananas, pears, or strawberries, and wherein the vegetables comprise at least lettuce, and wherein the nuts comprise at least almonds.

17. A method of making a dietary product that produces digestive glycemic response that is not produced when its ingredients are consumed separately and in amounts different to those found in the dietary product, the method comprising:
providing by weight content at least about:
75% to 85% fruits;
2% to 5% vegetables;
2% to 5% nuts; and
mixing and blending the fruits, vegetables, and nuts.

18. The method of claim 17, further comprising at least about 2% to 5% seeds, wherein at least some of the seeds are present in the fruits and/or at least some of the seeds are provided separately from the seeds present in the fruits.

19. The method of claim 17, further comprising at least about 2% to 5% seeds, wherein the seeds are only those seeds present in the fruits.

20. The method of claim 17, wherein the fruits comprise at least one of grapes, bananas, pears, or blueberries, and wherein the vegetables comprise at least lettuce, and wherein the nuts comprise at least almonds.
